(19) United States
(12) Patent Application Publication
(10) Pub. No.: US 2012/0162903 A1
(43) Pub. Date: Jun. 28, 2012

(54) ELECTRO-HYDRODYNAMIC COOLING FOR HANDHELD MOBILE COMPUTING DEVICE

(76) Inventors: Mark MacDonald, Beaverton, OR (US); Rajiv K. Mongia, Santa Clara, CA (US)

(21) Appl. No.: 12/978,392

(22) Filed: Dec. 23, 2010

(51) Int. Cl. G06F 1/20

(52) U.S. Cl. 361/679.46

(57) ABSTRACT

Embodiments of the invention are directed towards passive cooling systems for handheld mobile computing devices. An electro-hydrodynamic air mover (EAM) may be included in a handheld mobile computing device, the EAM to include an inlet and an outlet. The inlet and outlet are each included in at least one surface side of the handheld mobile computing device.

In embodiments of the invention the EAM produces an airflow by accelerating charged particles surrounding an electrode near the inlet towards an second electrode near the outlet in response to an electric field applied to the electrodes. The airflow will result from air drawn into the inlet of the EAM (i.e., air external to the computing device) and air expelled from the outlet of the EAM (i.e., air expelled away from the computing device).

### FIELD

Embodiments of the invention generally pertain to computing devices and more particularly to passive cooling systems utilized by handheld mobile computing devices.

### BACKGROUND

Computing systems and devices include components (e.g., processors) that generate heat. Typically the more powerful the component, the more heat it generates. Computing systems include mechanical fans to provide airflow to transfer heat generated by these components out of the system and transfer cooler air into the system. While mechanical fans provide for a simple and effective cooling solution, a system must accommodate the size and form factor of fans, which results in an increased volume in the system chassis.

Handheld mobile computing devices such as smartphones and tablet computers are designed to have a reduced volume to comply with expected user form factor. Furthermore, handheld devices typically have unibody chassis which are held by a user's hands (as opposed to, for example, laptop computers which typically have separate chassis for the display and the keyboard), and thus have temperature limits based on user comfort levels. The capabilities of mobile device components are currently limited by these chassis temperature limits.

Thus, handheld devices typically utilize passive cooling solutions—fans are undesirable because in addition to the increase the system chassis volume, they produce unwanted effects such as fan noise and introduce moving parts to the device. With increasingly more processing power expected from mobile devices, an effective passive cooling solution is needed to allow for more powerful components to be utilized while preserving the expected user form factor.

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 includes rear-view and side-view block diagrams of an embodiment of the invention.

FIG. 2 includes rear-view and side-view block diagrams of an embodiment of the invention.

FIG. 3 includes rear-view and side-view block diagrams of an embodiment of the invention.

FIG. 4 includes front-view and side-view block diagrams of an embodiment of the invention.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of the invention are directed towards passive cooling systems for handheld mobile computing devices. An electro-hydrodynamic air mover (EAM) may be included in a handheld mobile computing device, the EAM to include an inlet and an outlet. The inlet and outlet are each included in at least one surface side of the handheld mobile computing device.

EAMs utilized by embodiments of the invention further include first and second electrodes, each near the inlet and outlet of the EAM respectively, and an ionization device. In some embodiments, the first electrode near the inlet includes the ionization device (e.g., a corona electrode). It is understood that an EAM may use a small corona discharge created at the first high potential electrode to ionize air molecules or particulates (or may be ionized close to the first electrode by other means). The ionized air molecules or particulates are then accelerated towards the second electrode by an electric field. Molecular collisions of ions with surrounding air molecules create a net motion of the surrounding air towards the second electrode. This net motion may create a bulk air flow which in turn may provide cooling for handheld mobile electronic devices. These EAMs are also referred to as “Ionic Wind Generators”, and have previously been used for spot cooling solutions and for air filtration systems.

Thus, in embodiments of the invention the EAM produces an airflow by accelerating ionized/charged particles surrounding the first electrode towards the second electrode in response to an electric field applied to the first and second electrodes. The airflow will be the result from air drawn into the inlet of the EAM (i.e., air external to the computing device) and air expelled from the outlet of the EAM (i.e., air expelled away from the computing device). Said airflow may alternatively be described as “bulk air movement” that flows across or within the handheld mobile electronic device.

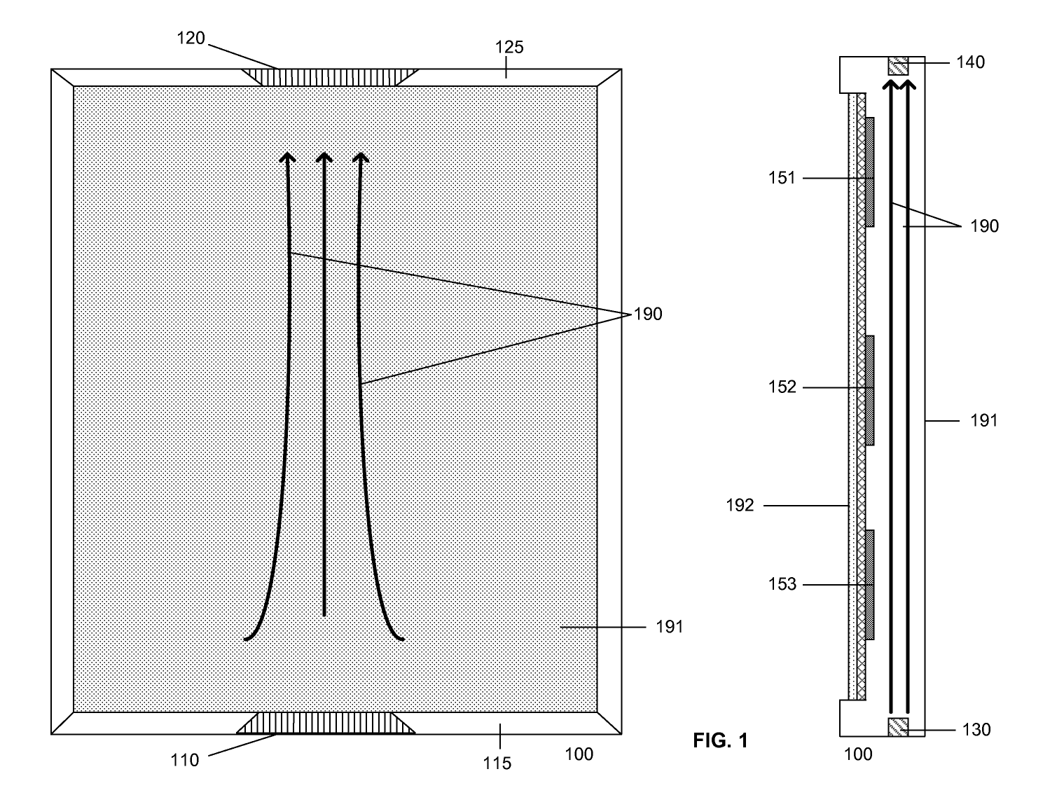

FIG. 1 includes rear-view and side-view block diagrams of an embodiment of the invention. In this embodiment, an EAM is included in handheld mobile computing device 100. It is to be understood that the phrase “handheld mobile computing device” may describe a smartphone, a personal digital assistant (PDA) a tablet computer (e.g., unibody tablet computer with a touch screen interface), or any similar device. In this embodiment, device 100 includes touch screen interface 192.

As described above, expected user form factor makes active system cooling solutions such as mechanical fans undesirable. The EAM of FIG. 1 provides for bulk air movement within an interior portion of the chassis of computing device 100—i.e., in this embodiment air external to device 100 enters the chassis of the system and air internal to the chassis is expelled from the system. It is thus clear that the EAM of FIG. 1 is distinguishable from solutions that provide spot cooling—i.e., solutions to provide air movement over specific computing components utilizing air within the device.

The EAM of FIG. 1 includes inlet 110 (included in surface side 115 of device 100) and outlet 120 (included in surface side 125). In this embodiment, the EAM further includes electrode pair 130, located at or near inlet 110. The EAM further utilizes an ionization device that charges particles that surround electrode pair 130. Said particles may comprise, for example, air molecules or dust particulates. As described above, said ionization device may be included in electrode pair 130, or may be a separate device (e.g., an ionization device utilizing a diode laser).

By applying an electric field to the electrode pair, the charged particles that surround electrode pair 130 are accelerated towards outlet 120. The charged particles collide and transfer momentum to neutral air particles between the electrode pair, thus resulting in bulk air movement between the inlet 110 to outlet 120 as illustrated by airflow 190. In other embodiments of the invention, device 100 may further include focusing electrodes (e.g. electrode 140) and other means (e.g., flow tubes) to ensure airflow 190 is directed as shown regardless of the orientation of device 100.

Thus, device 100 is passively cooled by airflow 190 generated by the EAM as described above. In this embodiment, airflow 190 passes directly over computing components 151, 152 and 153. Said computing components may be any components that produce heat and/or are susceptible to performance loss from heat, including central processing units (CPUs), graphics processing units (GPUs), and memory storage devices.

In this embodiment, inlet 110 and outlet 120 are included in opposing surface sides 115 and 125 respectively (each side adjacent to rear surface side 191). It is to be understood that in alternative embodiments, said inlet and outlet may be included in non-opposing surface sides of device 100 and still produce an airflow to provide bulk air movement as described above. Furthermore, the EAM of FIG. 1 may be used in combination with heat spreaders, heat sinks, direct attach heat exchangers, or remote heat exchangers to optimize platform cooling performance for the device.

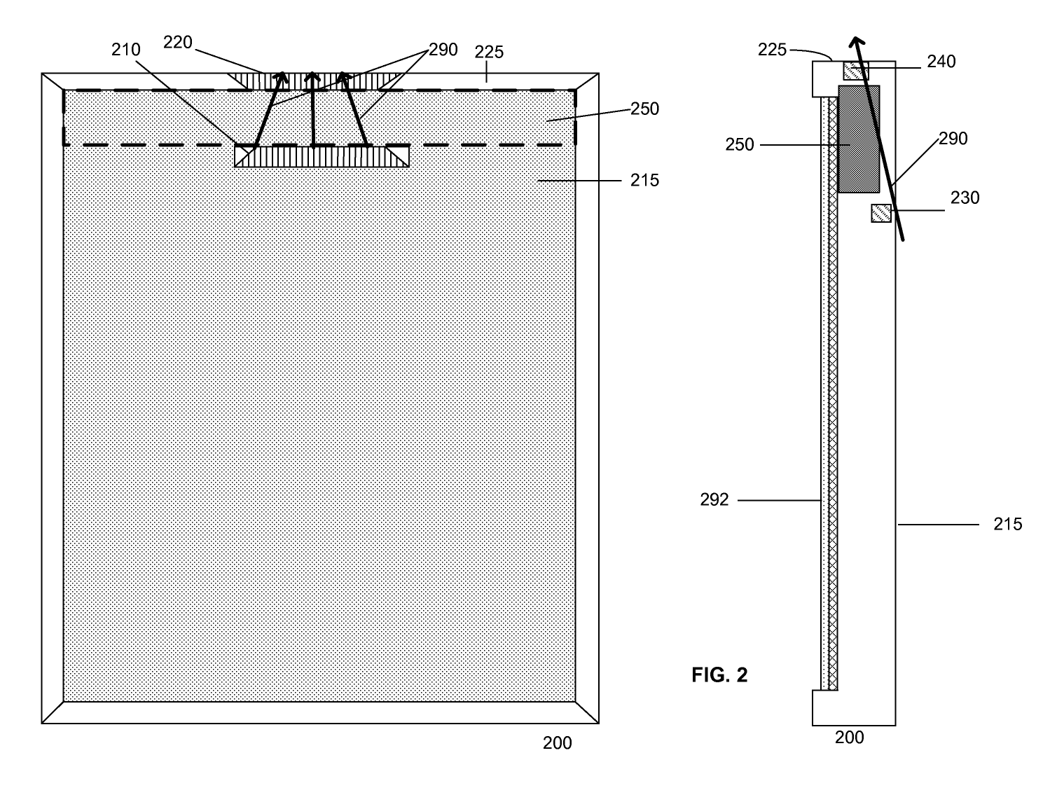

FIG. 2 includes rear-view and side-view block diagrams of an embodiment of the invention. In this example, mobile handheld computing device 200 includes an EAM working in combination with remote heat exchanger 250. Said remote heat exchanger may be a conventional remote heat exchanger as used in notebook designs (i.e., with a heat pipe or highly conductive spreader connecting heat producing components to the heat exchanger). Remote heat exchanger 250 may also include heat sink structures such as ribs, channels, fins, or other texturing surfaces to transfer (i.e., disperse) heat generated by components of device 200 to said heat sink structure.

It is to be understood that the operating temperature of remote heat exchanger 250 (especially the heat sink) may cause discomfort for a user of device 200, as it may possibly be held by the user's hand at or near its location.

To cool remote heat exchanger 250, device 200 includes an EAM to provide passive cooling near the remote heat exchanger. The EAM of FIG. 2 includes inlet 210 (included in rear surface side 215 of device 200, opposite of display 292) and outlet 220 (included in surface side 225) near heat exchanger 250. In this embodiment, the EAM further includes electrode pair 230, and any ionization means to charge particles that surround electrode pair 230. In some embodiments, device 200 may include focusing electrodes (e.g. electrode 240) to ensure airflow 290 is directed as shown.

By applying an electric field to the electrode pair, charged particles that surround electrode pair 230 are accelerated towards outlet 220. In contrast to the example embodiment shown in FIG. 1, inlet 210 and outlet 220 are each included in adjacent surface sides of device 200. Thus, it is to be understood that a smaller distance may be utilized by this embodiment compared to that of FIG. 1, as there is less impedance (i.e., distance) between electrode pair 230 and focusing electrode 240 than the electrodes of FIG. 1. The charged particles collide and transfer momentum to neutral air particles, thus resulting in bulk air movement to cool remote heat exchanger 250 as illustrated by airflow 290.

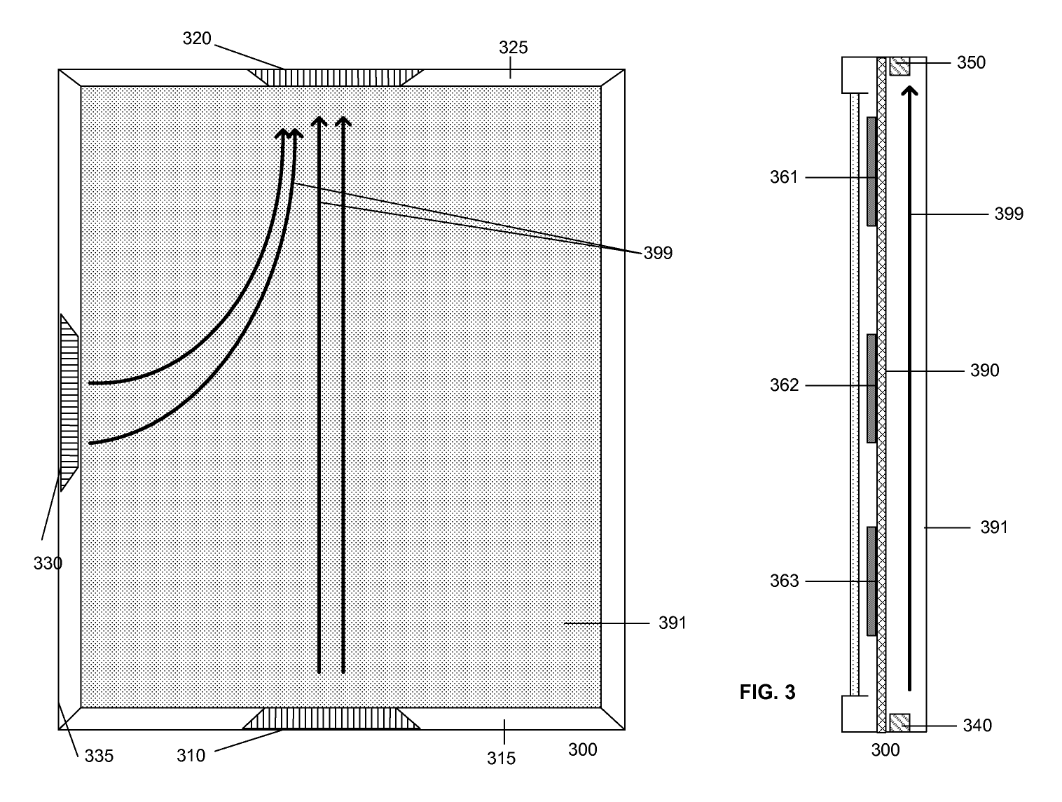

FIG. 3 includes rear-view and side-view block diagrams of an embodiment of the invention. In this embodiment, an EAM is included in handheld mobile computing device 300. Said EAM comprises multiple inlets and a single outlet. It is to be understood that in alternative embodiments, any number of inlets and outlets (i.e., at least one of each) may be utilized to provide for passive cooling.

In this embodiment, a portion of the chassis or bezel of device 300 is sealed off from the rest of the system, forming a duct. An EAM of any configuration is installed within the duct to create a forced convection cooling environment. Heat producing components of the system may be thermally connected to the walls of the duct in order to accomplish system cooling. The duct may be short as the EAM itself, or could be longer (e.g., up to the entire length of the system).

In this embodiment, device 300 includes first inlet 310 (included in surface side 315 of device 300), second inlet 330 (included in surface side 335) and outlet 320 (included in surface side 325). In this embodiment, the EAM further includes electrode pair 340, located at or near first inlet 310, focusing electrode 350, located at or near outlet 320, and a second electrode pair (not shown), located at or near second inlet 330. As described above, charged particles surrounding the first and second electrode pair collide and transfer momentum to neutral air particles between all three electrodes, thus resulting in bulk air movement as illustrated by airflow 399.

Device 300 further includes wall 390 that separates the computing components of the device from the EAM and resulting airflow 399. By separating the computing components of device 300 from the inlets and outlet of the EAM, said components are protected from external elements not related to airflow 399 that may enter the device via the inlets and outlet (e.g., water ingress).

In one embodiment, wall 390 comprises a heat spreading material (e.g., sheet metal), and provides further passive cooling to device 300. Thus, computing components 361, 362 and 363 may be thermally connected to wall 390 to transfer heat from each component to said wall. Air flow 399 passes through device 300 and over wall 390 to provide further passive cooling to the device.

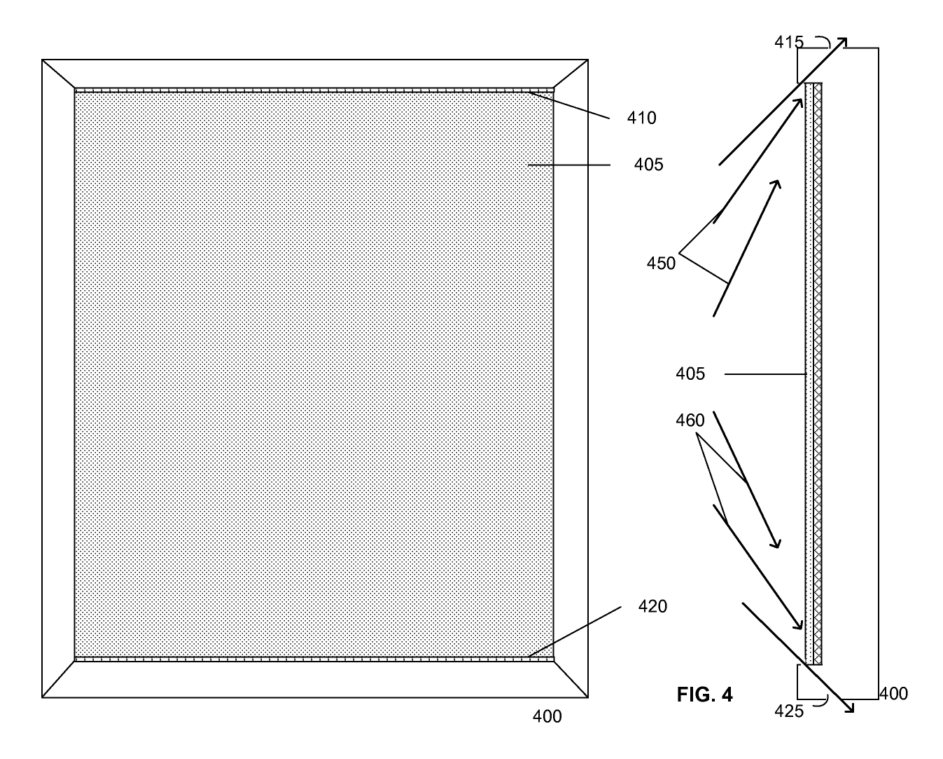

FIG. 4 includes front-view and side-view block diagrams of an embodiment of the invention. In this embodiment, mobile handheld computing device 400 includes an EAM comprising a plurality of inlets and outlets. It is to be understood that alternative embodiments may comprise a single inlet/outlet and still provide the functionality described below.

In this embodiment, device 400 includes touch screen interface 405. Thus, it may be desirable to cool the interface surface to a temperature suitable for user interaction. A low profile EAM inlet or outlet may be located at the edge(s) of touch screen interface 405. The EAM may blow air across the touch screen surface or draw air across the touch screen surface. In either case, the increased air speed near the surface of the touch screen will enhance convective dissipation from that surface. EAM(s) may be used on one or more edges of the screen, and may blow/suck parallel or opposite to one another, or may be at 90 degree angles.

In this embodiment, the EAM of device 400 includes inlets 410 and 420 located near display surface 405. The EAM further includes corresponding outlets 415 and 425. In this embodiment, electrodes and ionization devices located at or near the inlets/outlets are utilized as described above to create airflows 450 and 460. Thus, the EAM of device 400 produces airflows 450 and 460 to pull air near the edges of touch screen display surface 405, thereby providing for passive cooling for the input means of the device. Because airflows 450 and 460, as shown, pull air into device 400 via inlets 410 and 420 and expel air from the device via outlets 415 and 425, the bulk air movement that is generated flows through the device chassis similar to the alternative embodiments described above.

It is to be understood that embodiments of the invention may utilize one or more EAMs of various widths and thicknesses (effective EAMs with thicknesses as thin as 1 mm are feasible). Furthermore, embodiments of the invention may also employ one or more electro-hydrodynamic spot coolers on heat generating components for added cooling. Additional EAMs and electro-hydrodynamic spot coolers may share a common power/voltage source, may be independently driven, or any combination therein.

In alternative embodiments, EAMs could be paired with porous chassis materials, including but not limited to porous plastics, porous metals, fabrics (including hydrophobic membranes), or any functional equivalents. It is understood that these embodiments may take advantage of the distributed character of the EAM inlets/outlets and help preserve the handheld mobile computing device form factor, look and feel.

Reference throughout the foregoing specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout the specification are not necessarily all referring to the same embodiment. Furthermore, the particular features, structures or characteristics may be combined in any suitable manner in one or more embodiments. In addition, it is appreciated that the figures provided are for explanation purposes to persons ordinarily skilled in the art and that the drawings are not necessarily drawn to scale. It is to be understood that the various regions, layers and structures of figures may vary in size and dimensions.

In the foregoing detailed description, the method and apparatus of the present invention have been described with reference to specific exemplary embodiments thereof. It will, however, be evident that various modifications and changes may be made thereto without departing from the broader spirit and scope of the present invention. The present specification and figures are accordingly to be regarded as illustrative rather than restrictive.

1. An apparatus comprising:
a handheld mobile computing device; and
an electro-hydrodynamic air mover (EAM) included in the handheld mobile computing device, the EAM to include
a first electrode,
a second electrode, an inlet, and
an outlet, wherein the inlet and outlet of the EAM are each included in at least one surface side of the handheld mobile computing device;
the EAM to produce an airflow by accelerating at least one of charged air molecules and charged particulates surrounding the first electrode towards the second electrode in response to an electric field applied to the first and second electrodes, the airflow to be produced from air drawn into the inlet of the EAM and air expelled from the outlet of the EAM.

2. The apparatus of claim 1, wherein the inlet and the outlet of the EAM are each included in opposite surface sides of the handheld mobile computing device.

3. The apparatus of claim 1, wherein the inlet and the outlet of the EAM are each included in adjacent surface sides of the handheld mobile computing device.

4. The apparatus of claim 1, wherein the inlet is adjacent to a display of the handheld mobile computing device, the airflow to flow along the display of the mobile computer device.

5. The apparatus of claim 1, the airflow to flow through an internal duct of the mobile computer device.

6. The apparatus of claim 5, the internal duct formed in part by a wall separating computing components from the airflow.

7. The apparatus of claim 6, wherein the wall separating computing components from the airflow comprises a thermally conductive material, at least one computing component of the handheld mobile computing device coupled to an interior side of the wall, the airflow to flow along an exterior side of the wall.

8. The apparatus of claim 1, further comprising a heat exchanger included in the handheld mobile computing device, wherein the outlet of the EAM is coupled to the heat exchanger.

9. The apparatus of claim 1, wherein the first electrode of the EAM comprises a corona discharge electrode to ionize at least one of the air molecules and the particulates surrounding the first electrode.

10. A method comprising:
applying an electric field between first and second electrodes of an electro-hydrodynamic air mover (EAM) included in a handheld mobile computing device, the application of the electric field to draw at least one of charged air molecules and charged particulates surrounding the first electrode towards the second electrode to create an airflow, the airflow produced from air drawn into an inlet of the EAM and air expelled from an outlet of the EAM;
wherein the inlet and outlet of the EAM are each included in at least one surface side of the handheld mobile computing device.

11. The method of claim 10, wherein the inlet and the outlet of the EAM are each included in opposite surface sides of the handheld mobile computing device.

12. The method of claim 10, wherein the inlet and the outlet of the EAM are each included in adjacent surface sides of the handheld mobile computing device.

13. The method of claim 10, wherein the inlet of the EAM is adjacent to a display of the handheld mobile computing device, the airflow to flow along the display of the mobile computer device.

14. The method of claim 10, the airflow to flow through an internal duct of the mobile computer device.

15. The method of claim 14, the internal duct formed in part by a wall separating computing components from the airflow.

16. The method of claim 15, wherein the wall separating computing components from the airflow comprises a thermally conductive material, and at least one computing component of the handheld mobile computing device is coupled to an interior side of the wall, the airflow to flow across an exterior side of the wall.

17. The method of claim 10, wherein the outlet of the EAM is coupled to a heat exchanger included in the handheld mobile computing device.

18. The method of claim 10, wherein the first electrode of the EAM comprises a corona electrode to ionize at least one of the air molecules and the particulates surrounding the first electrode.
